(19) United States
(12) Patent Application Publication
(10) Pub. No.: US 2009/0255130 A1
(43) Pub. Date: Oct. 15, 2009

(54) INSTRUMENT

(75) Inventor: Anders JALMBERGER, Eskilstuna (SE)

Correspondence Address: THE MAXHAM FIRM, 9330 SCRANTON ROAD, SUITE 350, SAN DIEGO, CA, 92121, US

(73) Assignee: SUNDTORP INNOVATION AB, Eskilstuna (SE)

(21) Appl. No.: 12/474,211

(22) Filed: May 28, 2009

Related U.S. Application Data
(63) Continuation of application No. PCT/SE2007/050835, filed on Nov. 12, 2007.

(30) Foreign Application Priority Data
Dec. 1, 2006 (SE) 0602573-8

(51) Int. Cl. B26B 13/28

(52) U.S. Cl. 30/266

(57) ABSTRACT

An instrument having two branches such as a pair of scissors, or the like. The two branches thereof are connected with a coupling element, which is attached to one of the branches and extends through a hole in the other branch. The coupling element has a locking body situated on the outside of the other branch. Both the locking body and the hole are out of round so that the locking body can be brought through the hole in a certain angular position but not in another. According to the invention, the coupling element is screwed into the first branch. Furthermore, the locking body has a shape that is adapted in such a way to the shape of the hole that the coupling element can be turned by means of the second branch.

### FIELD OF THE INVENTION

In a first aspect, the present invention relates to a dismountable instrument, such as, for instance, a pair of scissors, a pair of pliers, a pair of artery forceps, needleholder, or vascular clamp comprising a first branch, a second branch pivotable in relation to the first branch, and a coupling element connecting the branches, which coupling element consists of a circular-cylindrical pin attached to the first branch and provided with a locking body that extends radially outside the pin, which second branch is provided with a through hole through which the pin extends so that the locking body of the pin is situated on the side of the second branch that is facing away from the first branch, the radial extension of which locking body varies in the peripheral direction and which hole has a shape that comprises at least one circular-cylindrical wall portion and at least one wall portion situated radially outside the circular-cylindrical wall portion in such a way that the locking body is displaceable axially through the hole in a first pivotal position between the branches and is prevented from being axially displaced in a second angular position between the branches.

In a second aspect, the invention relates to a method for modifying an instrument of the above-mentioned type.

### BACKGROUND OF THE INVENTION

An instrument according to the invention is particularly suitable for use in hygienic demanding situations such as, for example, surgery or food handling, but is also applicable in other situations.

Today, there is a great problem in cleaning and sterilizing the surgical instruments that consist of two or more composed parts, of the type artery forceps, needleholders, vascular clamps, and so on, (so-called box-lock instruments) and scissors. The routines in the hospital are often good, the operation is carried out, the instruments are laid on a lattice and put into a washer disinfector. The instrument manufacturer informs about how the instruments should be cleaned, e.g., “when cleaning, open at an angle of 90°,” but it will not be totally clean. Dirt, such as blood and tissue debris, creeps in under screws and rivets, and gets burnt and stuck in the drying program. An instrument that is not entirely clean does neither become sterile upon autoclaving.

According to conventional technique, the coupling element consists of a screw that goes through a hole in the other branch and is screwed into a threaded hole in the other one.

It is not until the instrument is unscrewed that all dirt caught is seen. In the hospitals, instruments are not unscrewed, only if it says that the instrument is “dismountable,” which is not the case with scissors and box-lock instruments. Some scissors and all box-lock instruments are riveted and thereby not dismountable.

Thus, there is a problem by the fact that conventional surgical instruments are intricate to dismount and require tools, and therefore this often is neglected with the consequence that the sterilization becomes unsatisfactory.

Different solutions have been proposed to provide surgical instruments of similar types that facilitate dismounting of the branches of the instrument. Examples of this are seen in U.S. Pat. No. 2,214,985, U.S. Pat. No. 2,632,661, US patent publication 2005/0186536 and German patent DE 10101425.

U.S. Pat. No. 2,214,985 discloses a surgical clamp having three branches, which is dismountable by displacing the branches in relation to each other transverse to the longitudinal direction of the coupling element. However, this construction requires a complicated design of the branches as well as the coupling element.

U.S. Pat. No. 2,632,661 discloses a connecting link for two branches of a pair of surgical pliers wherein the branches are dismounted by an axial motion. The connecting link has a complicated design of the male part of the link as well as the female part thereof. Particularly the female part requires an undercut of the link area that is complicated for reasons of manufacturing technique.

US patent publication 2005/0186536 discloses a pair of dentist's pliers where the branches can be dismounted axially. The construction is similar to the one in U.S. Pat. No. 2,632,661 and entails the corresponding manufacturing technique difficulties. German patent DE 10101425 discloses a pair of surgical pliers having a link that allows exposure of a part of the surfaces of the link by a radial relative motion between the branches, but where the branches are not dismountable.

Furthermore, by US patent publication 2005/0120566 a pair of scissors is previously known where the two branches can be detachably connected by a pin on one of the branches and a hole in the other branch. The pin has a non-circular head and the hole has a non-circular cross-section, of the corresponding shape. The branches can be joined and dismounted axially in a certain mutual angular position when the head can pass through the hole. In other angular positions, this is prevented by the non-circular shapes. The pair of scissors is furthermore provided with cam surfaces, which press the branches against each other in an active angular position but not in a home position.

### SUMMARY OF THE INVENTION

A purpose of the present invention is to improve an instrument of a related type in respect of the precision of the compression force.

In the first aspect of the invention, the purpose set forth is attained by the fact that an instrument of the kind mentioned by way of introduction has the special features that the pin has a screw thread by which it is attached in a threaded hole in the first branch and in that the locking body, in a section perpendicular to the axis of the pin, has a shape that allows rotationally fixed connection with the hole of the second branch.

By this embodiment, dismounting is easily provided by turning the branches into the pivotal position where the body is allowed to pass through the hole, and then the branches are free to be dismounted axially. Thanks to the simplicity, this is carried out quickly, and no tool, such as a screwdriver, is required. By the simple dismounting, the risk that dismounting of the instrument is neglected when it is to be sterilized decreases, which increases the possibility of a complete sterilization. In addition, the constructive design of the connection between the branches is very simple and where, for instance, cut slots, are not required, which entails that the instrument can be manufactured at a low cost in comparison with previously known constructions of similar link connections.

Above all, the subject instrument gives great advantages as regards to attain precision of the compression force. Thanks to the pin being attached to the first branch by being screwed into the same, the axial position of the pin can easily be adjusted by turning the same. Thereby, the locking body of the pin will press at different levels against the outside of the second branch. This means that play can be eliminated and that the level of compression of the branches can be adjusted.

Furthermore, by the fact that the non-cylindrical cross-section of the locking body can be connected to the non-cylindrical hole in a rotationally fixed way, it is possible to screw the pin out of or into the first branch using the second branch as a tool. Thus, the compression force of the instrument can be adjusted without any separate tool being required for the same.

This is particularly advantageous when the instrument is a pair of scissors. Then it is important that the scissors run “just enough stiffly”, i.e., there should be such a great compression of the branches that the cutting edges provide a distinct cut. Simultaneously, it has to be avoided that the force becomes too great so that the pair of scissors will be uncomfortable to handle, Also in other types of similar instruments, such as, e.g., a pair of pliers, where a compression of the branches against each other is not required, the invention entails that play can be eliminated in a simple way.

According to a preferred embodiment of the invented instrument, the shape of the locking body corresponds to the shape of the hole of the second branch.

Thanks to such a shape conformance, it is easy to get good precision when the pin is to be screwed out or in thanks to the fact that there is no play in the rotary motion. It should be appreciated that with corresponds is meant that there is a sufficient gap to allow the pin to be inserted into the hole.

In addition, this entails that the angular position that allows axial displacement of the branches in relation to each other becomes precisely defined so that the risk of unintentional dismounting becomes small.

According to an additional embodiment, means are arranged adjacent to the fulcrum for the provision of a force that presses together the branches against each other, at least on the side of the fulcrum that is the active side of the instrument.

Thereby, play between the branches is avoided. In addition, the compressing force is useful in certain types of instruments. In, for example, a pair of scissors, it is important that the two edges are pressed against each other to provide an optimum cutting force and a precise cut.

According to an additional embodiment, said means comprise at least one contact surface of the first branch and at least one contact surface of the second branch, which contact surfaces are arranged to abut against each other, wherein at least one of said contact surfaces is a cam surface.

By the fact that one or both contact surfaces abutting against each other have a cam shape, a bias force is provided that depends on the mutual pivotal position of the branches, wherein possible play is eliminated in a simple way at the same time as the branches, at the active part thereof are pressed against each other for more efficient operation, particularly when applied to a pair of scissors. According to an additional preferred embodiment, the locking body comprises two diametrically opposite radially projecting portions and the hole comprises two diametrically opposite radially projecting axially running slots.

Thereby, a symmetry of the locking function is attained, which contributes to a more stable and precise keeping together of the branches of the instrument, which ensures proper function of the instrument.

According to an additional embodiment, the second branch is provided with a circular countersink around the hole at the side adjacent to the locking body, which countersink has a radius that is greater than the greatest radial extension of the locking part.

The countersink entails that the locking body will be situated entirely or partly within the outside of the branch. Thereby, it is avoided that a projecting locking body may be disturbing when handling the tool. The recess also entails the possibility of imparting the surface against which the locking body abuts another shape, e.g., a plane shape or with a certain slope than the shape of the surface on the outside of the branch, the latter of which, for other reasons, may desirably be given another shape, e.g., arched.

In a second aspect of the invention, the purpose set forth is attained by a method for modifying a dismountable instrument, such as, e.g., a pair of scissors, a pair of pliers, a pair of artery forceps, needleholder, or vascular clamp comprising a first branch and a second branch pivotable in relation to the first branch that are connected by a screw that extends through a circular-cylindrical hole in the second branch and is screwed into a threaded hole in the second branch, comprising the special measures of: dismounting the instrument by loosening the screw from the branches, providing a coupling element, which coupling element has a screw thread adapted to the threaded hole of the first component, a pin having a diameter adapted to the hole of the second component, and a locking body that extends radially outside the pin, at least one axially running through groove being recessed in the hole of the second component, which groove(s) has/have a shape that allows axial passage of the locking part through the hole in a first angular position between the components and that blocks such a passage in a second angular position between the components, the branches being assembled.

According to a preferred embodiment of the method, in the modification, measures are taken to impart the modified instrument the features defined for the instrument according to any one of the preferred embodiments of the same. By the invented method, an instrument is provided in accordance with the invented instrument and will thereby present the corresponding advantages that have been accounted for above for the same and the preferred embodiments of the same.

### BRIEF DESCRIPTION OF THE DRAWING

The invention is further described below by means of the subsequent detailed description of advantageous embodiment examples of the invention, reference being made to accompanying drawing, wherein:

FIG. 1 is a side view of a first embodiment example of an instrument according to the invention in a first pivotal position;

FIG. 2 is a side view of the instrument in FIG. 1 in a second pivotal position;

FIG. 3 is a side view from the outside of a first detail in FIG. 1;

FIG. 4 is a side view from the inside of the detail in FIG. 3;

FIG. 5 is a side view from the outside of a second detail in FIG. 1;

FIG. 6 is a side view from the inside of the detail in FIG. 5;

FIG. 7 is an enlarged section along the line VII-VII in FIG. 4;

FIG. 8 is a first side view of a third detail in FIG. 1.

FIG. 9 is a second side view of the detail in FIG. 8;

FIG. 10 is a view from above of the detail in FIG. 8; and

FIG. 11 is a side view of a second embodiment example of an instrument according to the invention.

### DETAILED DESCRIPTION OF THE PREFERRED EMBODIMENTS

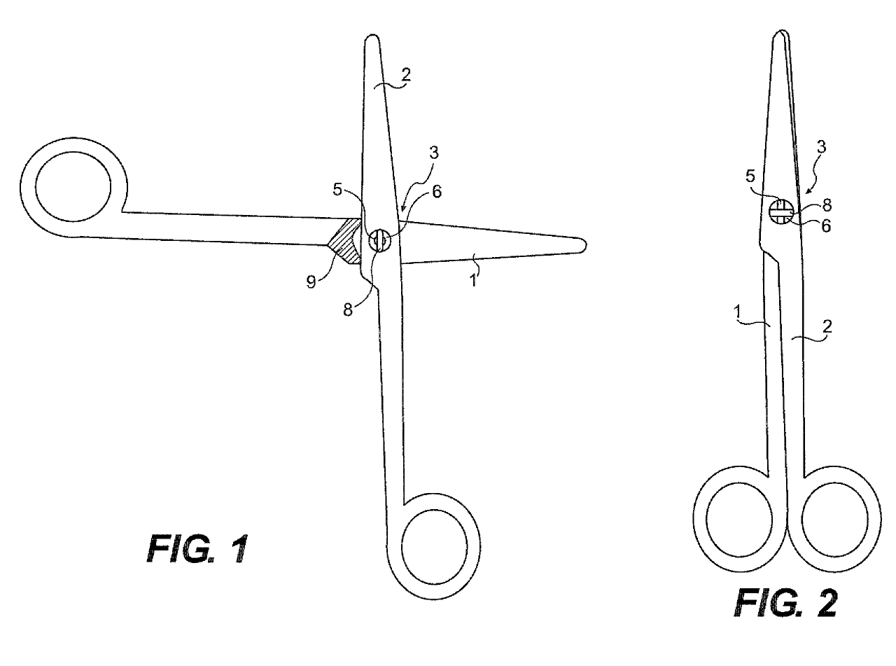

In FIG. 1, a pair of surgical scissors is illustrated in a side view in a pivotal position with the two branches 1, 2 being essentially perpendicular to each other. The branches are pivotably connected with a coupling element 3, which is fixedly connected with the first branch 1 and extends through a hole 5 in the second branch 2. In the position shown in the figure, the two branches can be dismounted from each other in the axial direction by the fact that a locking body 8 of the coupling element 3 can pass through the hole 5 having a complementary shape. The inside of the branch 1 is provided with a contact surface 9 arranged for cooperation with a corresponding contact surface on the inside of the second branch.

FIG. 2 illustrates the same pair of scissors in the same side view but with the branches 1, 2 in a maximally collapsed position with the same being essentially parallel to each other. In this position, the two branches are held to each other as a consequence of the mutual pivotal positions of the coupling element 3 and of the hole 5. As is seen in FIG. 1 as well as FIG. 2, the coupling element mouths in a countersink 6 on the outside of the second branch.

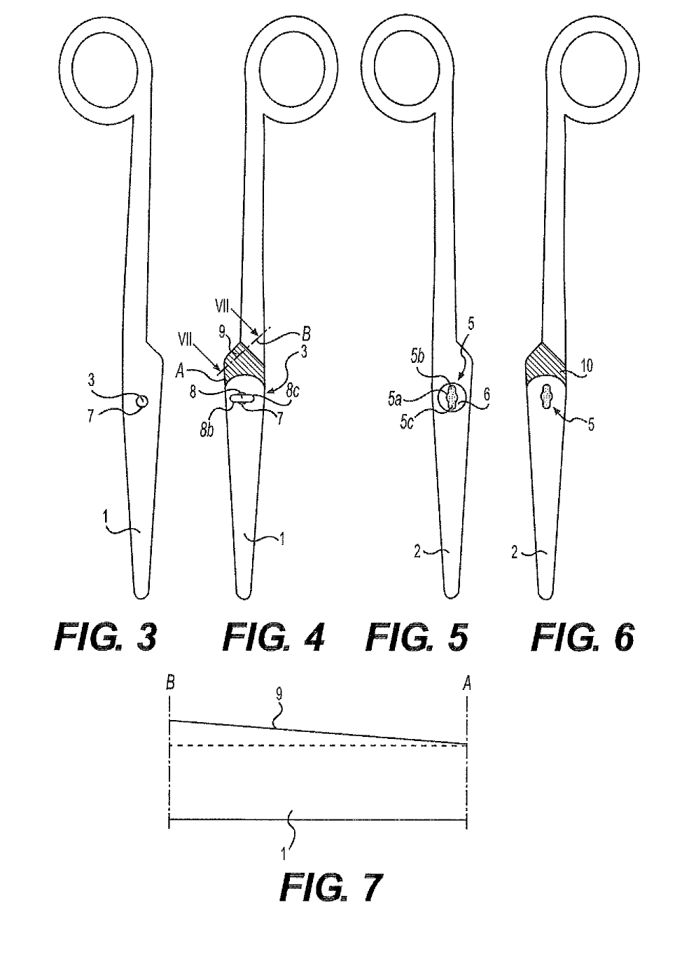

In FIG. 3, the first branch 1 is shown from the outside. It is provided with a threaded hole 7 into which the coupling element 3 is screwed. In FIG. 4, the same branch 1 is shown from the inside where the locking body 8 of the coupling element 3 having diametrically projecting portions 8b, 8c is visible. On the inside, the branch 1 has a contact surface 9 intended for abutment against a corresponding contact surface 10 on the inside of the second branch 2.

In FIG. 5, the second branch 2 is shown from the outside where the hole 5 thereof is entirely visible. The hole 5 has a central cylindrical portion 5a and two diametrically projecting portions 5b, 5c.

The same hole 5 is also seen in FIG. 6, which shows the inside of said branch 2.

The two contact surfaces 9, 10 of the inside of the respective branch 1 , 2 will, upon a cutting motion, slide with pressure against each other. Thereby, the two scissor edges are pressed against each other. The two surfaces may be plane and parallel to each other.

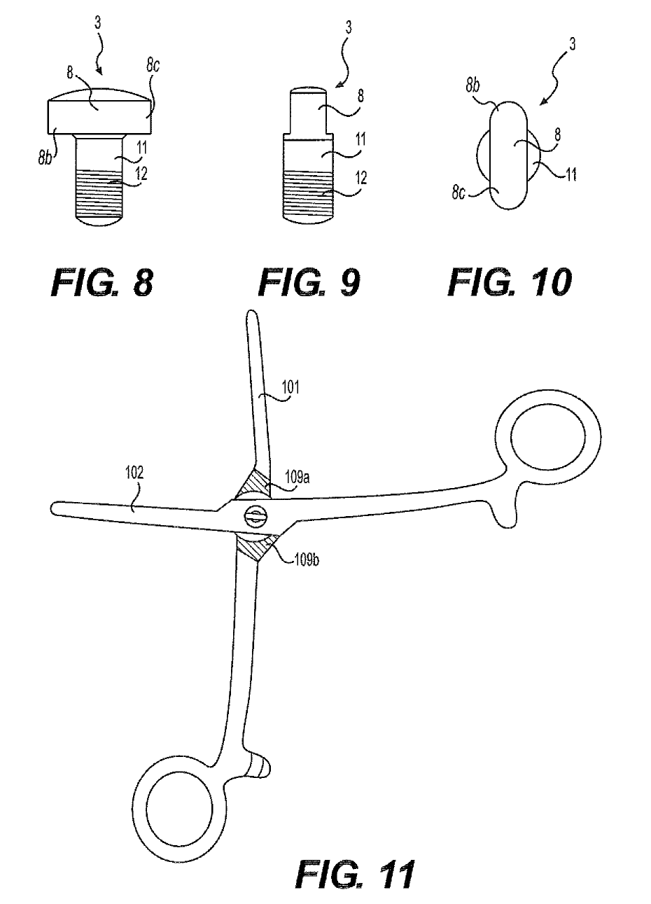

According to an advantageous embodiment, one of the contact surfaces 9 is inclined, such as is shown in FIG. 7 illustrating a section from A to B along the line VII-VII in FIG. 4. In the figure, the inclination is exaggerated for the sake of clarity. When cutting is carried out and the branches are turned toward the position where they become increasingly parallel, the contact surface 10 of the second branch 2 will be displaced upward on the inclined contact surface 9 of the first branch 1 so that the abutment force between them increases. This entails that the branches are pressed together stronger the more closed the pair of scissors is. In FIGS. 8-10, the coupling element 3, with which the branches 1, 2 are connected, is illustrated. It consists of a pin 11 having a screw thread 12 and a locking body 8. In the figure, the shape of the locking body is more clearly seen, having two radially projecting portions 8b, 8c. In the example shown, the locking body has a width less than the diameter of the pin, but the width thereof may be up to equal to this diameter.

With the screw thread 12 thereof, the pin 3 is screwed into the hole 7 in the first branch. Screwing in and out of the same may be effected by using the second branch 2 as a spanner, where the holes 5 thereof provided with projections 5b, 5c mate around the contour of the locking body 8. In that way, the axial distance of the locking body 8 in relation to the branch 1 can be adjusted and thereby how firmly the second branch 2 is clamped when it is angled in inside the locking body 8.

In FIG. 2, which illustrates the mutual position between the branches where the same can be mounted or dismounted, the longitudinal extension of the locking body 8 is approximately perpendicular to the longitudinal direction of the first branch 1 and the two branches are consequently perpendicular to each other. If the axial position of the locking body 8 is adjusted by turning the coupling member 3 such as described above, the longitudinal extension of the locking body 8 will no longer be perpendicular to the longitudinal direction of the branch 1. Mounting/dismounting is then effected at another mutual angular position between the branches 1, 2. Naturally, it should be avoided that the coupling member 3 is turned into a position where the longitudinal extension of the locking body 8 is almost parallel to the longitudinal extension of the branch 1, since the branches then become dismountable in the position where the pair of scissors is active. Therefore, it should avoided to position the locking body within an interval of ±15° from the parallel position, which by a wide margin affords the requisite adjustment interval for the axial position of the locking body 8. In FIG. 11, the invention is illustrated applied to a pair of pliers having branches 101, 102. On the inside thereof, each branch has two contact surfaces 109a, 109b, one on either side of the fulcrum, a so-called box-lock instrument. In other respects, the pair of pliers has the corresponding functions as have been described for the pair of scissors illustrated in FIGS. 1-10.

What is claimed is:

1. A dismountable instrument comprising:
a first branch;
a second branch pivotable in relation to the first branch; and
a coupling element connecting the first and second branches, said coupling element comprising a circular-cylindrical pin attached to the first branch and provided with a locking body that extends radially outside the pin, said second branch being provided with a through hole through which the circular-cylindrical pin extends so that the locking body of the pin is situated on the side of the second branch that is facing away from the first branch, the radial extension of said locking body varying in the peripheral direction and said through hole having a shape that comprises at least one circular-cylindrical wall portion and at least one wall portion situated radially outside the circular-cylindrical wall portion in such a way that the locking body is displaceable axially through the through hole in a first pivotal position between the branches and is prevented from being axially displaced in a second angular position between the branches;
said pin having a screw thread by which it is attached in a threaded hole in the first branch; and
the locking body, in a section perpendicular to the axis of the pin, having a shape that allows rotationally fixed connection with the hole of the second branch.

2. The dismountable instrument according to claim 1, wherein said shape of the locking body corresponds with the shape of the hole of the second branch in a section perpendicular to the axis of the pin.

3. The instrument according to claim 1, wherein contact surface means are arranged adjacent to the fulcrum for the provision of a force that presses the branches against each other, at least on the side of the fulcrum that is the active side of the instrument.

4. The instrument according to claim 2, wherein contact surface means are arranged adjacent to the fulcrum for the provision of a force that presses the branches against each other, at least on the side of the fulcrum that is the active side of the instrument.

5. The instrument according to claim 3, wherein said contact surface means comprise at least one contact surface of the first branch and at least one contact surface of the second branch, which contact surfaces are arranged to abut against each other, at least one of said contact surfaces being a cam surface.

6. The instrument according to claim 4, wherein said contact surface means comprise at least one contact surface of the first branch and at least one contact surface of the second branch, which contact surfaces are arranged to abut against each other, at least one of said contact surfaces being a cam surface.

7. The instrument according to claim 1, wherein the locking body comprises two diametrically opposite radially projecting portions and the hole comprises two diametrically opposite radially projecting axially running slots.

8. The instrument according to claim 5, wherein the locking body comprises two diametrically opposite radially projecting portions and the hole comprises two diametrically opposite radially projecting axially running slots.

9. The instrument according to claim 1, wherein the second branch is provided with a circular countersink at the side adjacent to the locking body, which countersink has a radius that is greater than the greatest radial extension of the locking body.

10. The instrument according to claim 3, wherein the second branch is provided with a circular countersink at the side adjacent to the locking body, which countersink has a radius that is greater than the greatest radial extension of the locking body.

11. The instrument according to claim 5, wherein the second branch is provided with a circular countersink at the side adjacent to the locking body, which countersink has a radius that is greater than the greatest radial extension of the locking body.

12. The instrument according to claim 7, wherein the second branch is provided with a circular countersink at the side adjacent to the locking body, which countersink has a radius that is greater than the greatest radial extension of the locking body.

13. A method for modification of a dismountable instrument comprising a first branch and a second branch pivotable in relation to the first branch, the first and second branches being connected by a screw that extends through a circular-cylindrical hole in the second branch and is screwed into a threaded hole in the first branch, the method comprising:
dismounting the instrument by loosening the screw from the branches;
providing a coupling element, which coupling element has a screw thread adapted to the threaded hole of the first branch, a pin having a diameter adapted to the hole of the second branch, and a locking body that extends radially outside the pin;
at least one axially running through groove is recessed in the hole of the second branch, which groove has a shape that allows axial passage of the locking part through the hole in a first angular position between the branches and that blocks such a passage in a second angular position between the branches; and
assembling the branches.

14. The method according to claim 12, wherein, in the modification, measures are taken to impart to the modified instrument the features defined for the instrument according to claim 1.
